(19) United States
(12) Patent Application Publication
(10) Pub. No.: US 2024/0282022 A1
(43) Pub. Date: Aug. 22, 2024

(54) SCALABLE SPECTRAL TIME SERIES CONVERSION SYSTEM AND METHOD

(71) Applicant: Microsoft Technology Licensing, LLC, Redmond, WA (US)

(72) Inventor: Dmitry Valentinovich KHOLODKOV, Seattle, WA (US)

(73) Assignee: Microsoft Technology Licensing, LLC, Redmond, WA (US)

(21) Appl. No.: 18/171,093

(22) Filed: Feb. 17, 2023

(51) Int. Cl. G06T 11/20; G06F 16/26; G06T 11/00

(52) U.S. Cl. CPC G06T 11/206; G06F 16/26; G06T 11/001

(57) ABSTRACT

A system and method for generating a visualization graph for time series telemetry data includes identifying each unique, sequential data value pair in the time series data. A frequency of occurrence of each of the unique data value pairs in the time series telemetry data is then determined. A visualization graph is then generated for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

### BACKGROUND

In order to optimize performance of various programs, software developers traditionally seek to find and remove sources of problems and failures of a software product during product testing and after product release. To achieve this, many software venders seek to keep track of the operation of software products over time by continuously collecting data (often referred to as telemetry data) related to the use and performance of the software over time. Telemetry data is typically collected in time series format. Time series is a sequence of observations of categorical or numeric variables indexed by a date, or timestamp. Time series data can be analyzed to identify data characteristics, such as variations, fluctuations and anomalies, which may be indicative of software performance (e.g., errors, failures, bugs, etc.).

Time series analysis tools may be used to extract meaningful statistics and other characteristics in time series data in a manner that facilitates visualization of the data by operators (i.e., humans). However, it is often difficult to identify fluctuations and anomalies in time series telemetry data because the amount of data generated is often too large for processing and/or analysis. For example, large-scale software products and services can produce millions of rows of time series telemetry data every second. Existing time series analysis tools, however, are only capable of processing a limited number of time series for visualization and analysis purposes. For example, existing tools are generally only capable of handling a maximum of 3,000 time series, depending on the type of data, before running out of memory. Furthermore, fluctuations and anomalies in time series data indicative of software performance can have various configurations and permutations which further increases the complexity of analyzing the data.

In order to achieve large-scale processing and analysis of software telemetry data logs, particularly time series telemetry data, improved systems and methods of processing and analyzing time series are needed.

### SUMMARY

In one general aspect, the instant disclosure presents a data processing system having a processor and a memory in communication with the processor wherein the memory stores executable instructions that, when executed by the processor, cause the data processing system to perform multiple functions. The function may include identifying each unique data value pair in at least one time series telemetry data generated based on operation of at least one software application, each of the unique data value pairs including a first data value and a second data value, the first data value being generated at a first time in the time series, the second data value being generated at a second time in the time series, the second time being immediately before or after the first time, and wherein the first data value is different than the second data value; determining a frequency of occurrence of each of the unique data value pairs in the time series telemetry data; and generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

In yet another general aspect, the instant disclosure presents a method for generating a visualization graph for telemetry data includes pre-processing at least one time series telemetry data generated based on operation of at least one software application by smoothing and/or rounding data values in the time series data; identifying each unique data value pair in the time series telemetry data, each of the unique data value pairs including a first data value and a second data value, the first data value being generated at a first time in the time series, the second data value being generated at a second time in the time series, the second time being immediately before or after the first time, and wherein the first data value is different than the second data value; determining a frequency of occurrence of each of the unique data value pairs in the time series telemetry data; and generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

In a further general aspect, the instant application describes a non-transitory computer readable medium on which are stored instructions that when executed cause a programmable device to perform functions of identifying each unique data value pair in the time series telemetry data, each of the unique data value pairs including a first data value and a second data value, the first data value being generated at a first time in the time series, the second data value being generated at a second time in the time series, the second time being immediately before or after the first time, and wherein the first data value is different than the second data value; determining a count of occurrences of each of the unique data value pairs in the time series telemetry data; and generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example data processing engine for processing and visualizing telemetry data.

FIG. 3 depicts an example time series.

FIG. 4 is a table showing the data values for each unit of time in the time series of FIG. 3.

FIG. 5 shows a table of the spectral data for the data value pairs of FIG. 4.

FIG. 6 depicts a visualization graph based on the spectral data from the table of FIG. 5.

FIG. 7A is a graph of a first set of time series data generated by a process during a time period.

FIG. 7B is an example of a visualization graph of the time-series data of FIG. 7A generated by the data processing engine of FIG. 2.

FIG. 8A is a graph of a second set of time series data generated by a process during a time period.

FIG. 8B is an example of a visualization graph of the time-series data of FIG. 8B generated by the data processing engine of FIG. 2.

FIG. 9A is a graph of a 3D time series.

FIG. 9B is an example of a visualization graph of the 3D time-series of FIG. 9A.

FIG. 10 is a flow diagram depicting an example method for generating a visualization graph for time series telemetry data.

FIG. 11 is a block diagram of an example computing device, which may be used to provide implementations of the mechanisms described herein; and

FIG. 12 is a block diagram illustrating components of an example machine configured to read instructions from a machine-readable medium.

### DETAILED DESCRIPTION

Telemetry systems capture data associated with a software application (e.g., an Operating Systems, a desktop application, a web-based application, or any other software process being executed by a processor) at runtime when a particular section or line of code has executed. For example, when opening a file in an application, a “file open” telemetry event may be emitted. When a menu option is used to copy data, a “data copied” event may be transmitted. For each application or software instance, there may be different types of telemetry events that are reported, such as, for example, anytime a task is executed, the number of times a user selects (e.g., clicks) an application or icon, time required for an application to respond to a user request, time required for an application to start, and usage frequency of particular features of the application, etc., which may provide information or details related to the operation of the application and assist in any analysis. The telemetry data are often transmitted from user client devices to a central location for aggregation and storage. When aggregated, the collected data is used to generate large data logs.

Telemetry data is typically collected in time series format. Many applications can generate millions of lines of time series data per second. As a result, telemetry data logs sometimes include billions or trillions of rows of time series data. Although time series data can be helpful in data-driven problem solving and decision making, analyzing the large numbers of time series can be prohibitively complex, if not impossible, with existing analysis tools. As noted above, existing tools are generally only capable of enabling visualization of 3000 time series, depending on the type of data, before running out of memory. As a result, existing time series analysis tools are generally not capable of identifying and/or visualizing variations, fluctuations, and/or anomalies in time series signals that could provide meaningful information to an operator. As such, there exists a technical problem of lack of efficient mechanisms for processing and analyzing large numbers of time series signals to detect meaningful characteristics, such as variations, fluctuations, and anomalies, indicative of software performance and that enables the detected characteristics to be easily visualized and analyzed by a human user.

To address these technical problems and more, in an example, this description provides technical solutions in the form of systems and methods to collect, analyze, condense, and visually present time-series data in a graphical format. The systems and methods described herein utilize a highly efficient spectral time series conversion and condensing method that enables data from a large number (e.g., greater than 3K) of time series to be converted to spectral data and condensed into a much smaller number of data points that can significantly simplify storage and analysis of the data including, for example, diagnostic analysis of fluctuations in telemetric service behavior. The systems and method described herein are, among other things, able to distinguish between significant drops in reliability and normal operation deviations.

To perform spectral conversion and condensing of time series data, unique data value pairs are identified in the time series data that are sequential and not equal to each other. The count, or frequency, of each unique value pair in the time series data is then determined. A visualization graph is then generated from the unique data value pairs and their corresponding frequencies. The spectral data conversion and condensation enables compact visual representation of the data that captures the characteristics of the time series data fluctuation while preserving the density of the fluctuations. The visualization graph captures the characteristics of time series data fluctuations and can streamline interpretation of the time series data for any given duration of time. The visualization graph enables human operators to survey and understand 50K time series on a single page in a compact human readable format.

The technical solutions described herein address the technical problem of inefficiencies and difficulties in processing and analyzing large telemetry data sets associated with operations of software applications. The technical solutions provide for use of a time series data processing element that calculates spectral density of terms encountered in data logs and strength of relationships between various terms in the data logs over a given time period and visualizes both the density and the strength on an ellipsoidal visualization graph. The technical effects at least include (1) improving the efficiency of the process of analyzing large telemetry data sets; and (2) improving the efficiency of managing software applications by quickly identifying anomalies in the operation of the software application.

As used herein, the terms “telemetry data” and “data log” may be used interchangeably to refer to a collection of data associated with operations of a software application or system. The data may be collected from various computer devices as the software application is being used by users and aggregated to create one or more logs. In some implementations, the data logs are textual logs containing rows of textual data that logs operations of the software program as it is being executed on one or more devices. Furthermore, the term “software component” may be used herein to refer to any suitable type or types of software and may include any suitable set of computer-executable instructions implemented or formatted in any suitable manner. Software components may be implemented as application software, although the techniques described herein are applicable to other types of software components, such as system software (e.g., components of an operating system).

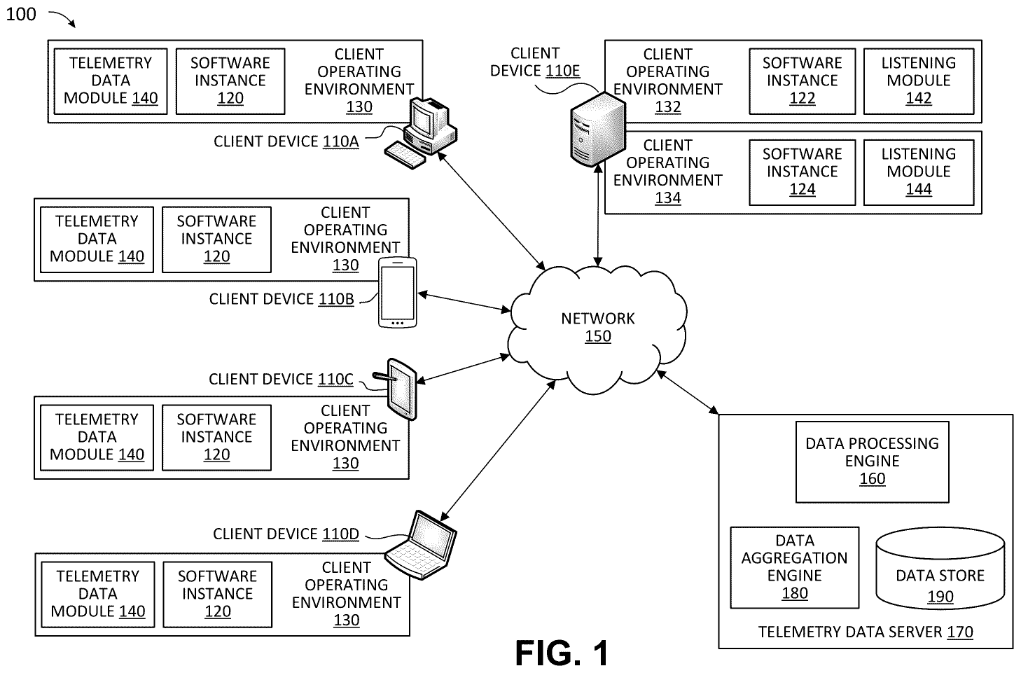

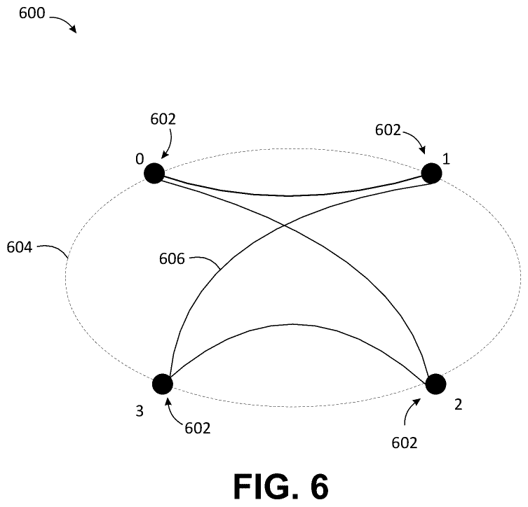

FIG. 1 illustrates an example system 100, upon which aspects of this disclosure may be implemented. The system 100 may include a number of client computing devices 110A-110E, which may also be referred to herein as client devices, client systems, and client information handling devices 110A-110E. In some implementations, one or more of the client devices 110A-110E, via a telemetry data module 140, communicates with a telemetry data server 170 via a network 150. The client devices 110A-110E are each a computing device capable of executing computer instructions, such as, but not limited to, a desktop computer 110A, smartphone 110B, a tablet computing device 110C, a notebook computer 110D, and a server computing system 110E. Examples of other types of client devices which may be used include phablets, smart watches, wearable computers, gaming devices/computers, televisions, and the like. The internal hardware structure of a client device is discussed in greater detail in regard to FIGS. 5 and 6.

In the example illustrated, the system 100 includes a single instance of a number of different types of computing devices 110A-110E, each having its own respective performance characteristics. However, it should be understood that this disclosure is not limited in this respect, and the techniques described herein can be used to collect information from a single computer, a set of multiple homogeneous types of computers, and/or non-homogeneous computers having any number of instances that operate individually or in parallel with other instances. It should also be noted that while 5 different computing devices 110A-110E are depicted in the system 100, many more computing devices may exist in systems utilizing the data analysis and processing methods disclosed herein.

In some implementations, the client devices 110A-110E (or collectively client device 110) each have one or more client operating environments 130 in which a software instance 120 of an installed software application is executed by the client device 110. An operating environment 130 may include hardware components of its respective client device 110 and resources (e.g., allocated amounts of partial resources) provided by the client device 110 for execution of the software instance 120, such as, but not limited to, compute (processor type, number of cores or processors, processor frequency, etc.), memory, storage, and network hardware and resources.

The client devices 110A-110E include virtual and/or physical computer processors, memories, communication interface(s)/device(s), and the like, which along with other components of the client device 110 are coupled to the network 150 via communication lines for communication with other entities of the system 100. In some implementations, the client devices 110A-110E send and receive data to and from other client devices 110 and/or to the telemetry data server 170 and may further analyze and process the data.

In some implementations, a client device 110 provides multiple operating environments 130 and/or software instances 120. An example of this is depicted with reference to the server computing system 110E, which includes a first operating environment 132 with a first software instance 122 and a first telemetry data module 142, as well as a second operating environment 134 with a second software instance 124 and a second telemetry data module 144. In some implementations, multiple operating environments operate concurrently, while in other implementations, they operate at different times, but with different configurations. For example, each of the first operating environment 132 and second operating environment 134 are associated with two different user accounts. In some implementations, first operating environment 132 and second operating environment 134 are virtualized operating environments, such as but not limited to virtual machines or containers. In some implementations, a single telemetry data module 140 is used for multiple operating environments 130 of a client device 110.

Client devices 110A-110E include a telemetry data module 140 that collects telemetry data generated based on the execution of software, such as the software instance 120 and/or client operating environment 130, on client devices 110A-110E. The telemetry data includes time series data which is comprised of a sequence of timestamped data points indexed in time order. Time series data is typically comprised of a sequence of timestamped data points indexed in time order. In embodiments, the data points comprise integer values indicative of a discrete value, state, level, and the like of a telemetry parameter or metric that pertains to the execution of a software application.

The telemetry data module 140 monitors the execution of the code as the software instance is operating, receives and/or generates telemetry data based on those operations and transmits the telemetry data to the telemetry data server 170 for processing. The telemetry data module 140 is configured to monitor the operation of and generate telemetry data for multiple software instances (e.g., for different software applications being executed on a client device). In some implementations, each software application (e.g., application instance 120) itself generates the telemetry data as the code is executed. For example, as the application instance 120 is being executed, it may generate data that logs the actions being taken by the software application. In some implementations, the telemetry data module 140 receives this telemetry data generated by the software application, performs some pre-processing operations on the telemetry data (e.g., aggregates the data, and/or removes some unnecessary data, etc.) before transmitting the telemetry data to the telemetry data server 170. In other implementations, the software application 120 itself transmits the telemetry data to the telemetry data server 170. It should be noted that while FIG. 1 depicts locally executed software applications, telemetry data may also be generated and collected for online applications. In such instances, the server executing the online application includes a telemetry data module and/or makes use of the online application instance to generate and transmit telemetry data as the application is executed.

The telemetry data server 170 is configured to process the received telemetry data to generate telemetry data logs that can be stored in a storage medium for future access and processing. To achieve this, the telemetry data server 170 makes use of a data aggregation engine 180 and a data store 190. The data aggregation engine 180 receives telemetry data pertaining to the software applications executed on multiple client devices 110. In embodiments, the data aggregation engine 180 parses the received data based on the type of application for which the data was generated and generates one or more data logs that includes the telemetry data. In embodiments, once the data is parsed by application, the data aggregation engine aggregates the telemetry data chronologically from multiple time series such that a data log of chronological telemetry data from multiple software applications is combined in a single data log. In some embodiments, each time series is included in a separate data log. In an example, a telemetry data log is generated for a given application every 24 hours. The frequency of data log generation and the time period for which telemetry data is aggregated may vary in different configurations. The generated data logs often contain billions and trillions of rows of time series data. In embodiments, the generated data logs are stored in a storage medium such as the data store 190. Although shown as a single data store, the data store 190 may be representative of multiple storage devices and data stores which may be connected to each of the various elements of the system 100. Moreover, while the data store 190 is depicted as being part of the telemetry data server 170, in some embodiments, the data is stored on a separate data server.

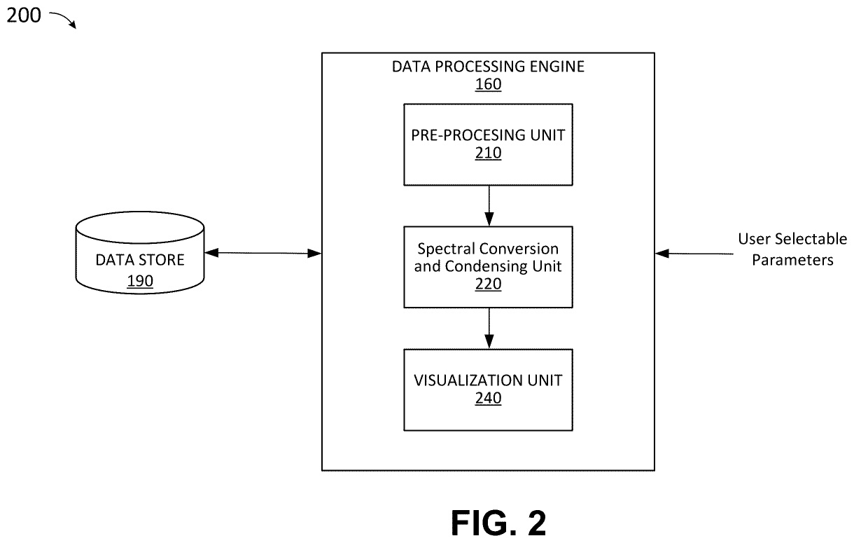

In order to enable analysis of the telemetry data received by the telemetry data server 170, the telemetry data server 170 makes use of a data processing engine 160 for processing and analyzing the telemetry data logs stored in the data store 190. As described in more details with regard to FIG. 2, the data processing engine 160 is configured to perform a spectral conversion and condensing method on the time series telemetry data that enables a visualization graph to be generated for a given time period. The visualization graph provides a high-level visualization of the telemetry data on one simplified graph and as such considerably simplifies the process of analyzing the large amount of telemetry data.

The network 150 is a conventional type, wired, wireless, and/or a combination of wired and wireless network and may have numerous different configurations, including a star configuration, token ring configuration, or other configurations. In embodiments, the network 150 includes one or more local area networks (LAN), wide area networks (WAN) (e.g., the Internet), public networks, private networks, virtual networks, mesh networks, peer-to-peer networks, and/or other interconnected data paths across which multiple devices may communicate. In embodiments, the network 150 is coupled to or include portions of a telecommunications network for sending data in a variety of different communication protocols. In some implementations, the network 150 includes Bluetooth® communication networks or a cellular communications network for sending and receiving data including via short messaging service (SMS), multimedia messaging service (MMS), hypertext transfer protocol (HTTP), direct data connection, WAP, email, and the like.

FIG. 2 illustrates an example system 200 that includes a data processing engine 160 configured to collect, analyze, condense, and visually present time-series telemetry data in a graphical format. The data processing engine of FIG. 2 includes a pre-processing unit 210, a spectral conversion and condensing unit 220, and a visualization unit 240. The data processing engine 160 receives a request for generating a visualization graph for a given time period from telemetry data associated with one or more applications or services. In embodiments, the request is received from a user via a user input device. In response to receiving the request, the data processing engine 160 retrieves the telemetry data log(s) from the data store 190 pertaining to the request. The data log(s) includes at least one time series of telemetry data for the given time period. As noted above, the time series processing methods described herein enable at least 50K time series to be processed and visualized in a single visualization graph.

The telemetry data log(s) with the time series data retrieved from the data store 190 is supplied to pre-processing unit 210. The pre-processing unit 210 is used to process the time series data to facilitate subsequent processing by the spectral condensing unit. Any suitable type of pre-processing is utilized to prepare the time-series data for spectral conversion and condensing. In embodiments, the pre-processing unit 210 performs smoothing and/or rounding of the time series data. Smoothing is a technique applied to time series to remove small variations between time steps which in turn can reduce noise and better expose the underlying signal. One method of smoothing is using a moving average of time series data values, as is known in the art. In embodiments, pre-processing is performed to round data values to discrete values to reduce the number of unique data values that appear in the time series. Rounding can be performed to the nearest integer, the nearest multiple of 5, the nearest multiple of 10, and the like. The smoothing and rounding of time series data values also functions to reduce the amount of time series data that needs to be represented on the visualization graph. In embodiments, pre-processing is based on predetermined and/or preselected threshold values, e.g., averages for smoothing, rounding parameters, etc. In embodiments, pre-processing thresholds are selectable values which can be set by a user, e.g., via a user input device.

The pre-processed time series data is then supplied to the spectral conversion and condensing unit 220. The spectral conversion and condensing unit 220 performs a spectral conversion and condensing process on the time series data that transforms the time series data into condensed spectral data. Spectral conversion, for the purposes of this disclosure, involves identifying each unique sequential data value pair in the time series data that exhibit a change in value (i.e., an increase or decrease), and the occurrence of each unique data value pair is then counted to determine a frequency value for each unique data value pair. Sequential data value pairs that do not exhibit a change (i.e., have the same value) are not identified and/or counted. Each data value from the unique data value pairs then only needs to be represented data values from the

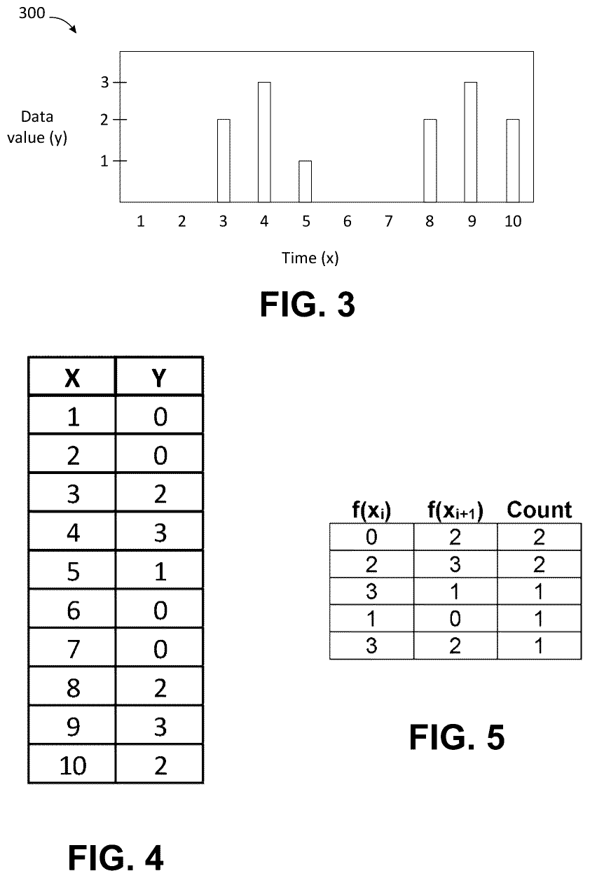

An example of spectral conversion and condensing will now be described with respect to FIGS. 3-5. FIG. 3 depicts a graph of a small time series 300 generated during a time period (x=1 . . . 10) with data values (y=1 . . . 3). FIG. 4 shows a table of the time series of FIG. 3 having a first column that holds sequential time values (x) and a second column having the telemetry data values (y) generated at each time x (i.e., y=f(x)). FIG. 5 is an example of the condensed representation of the data set of FIGS. 3 and 4 that would be generated by the data condensing unit of FIG. 2. The first pair of adjacent data points in the time-series shown in the table of FIG. 4 is (1,0) and (2,0). The measured value (y) of the two adjacent data points (in this case f(xi)=0 and f(xi+1)=0) are compared and determined to be the same value so this data value pair is not counted. The second pair of adjacent data points in the table of FIG. 4 is (2,0) and (3,2). These two sequential data points are different (i.e., “0” and “2”). Accordingly, the (0, 2) is identified as a unique data value pair which is added to the table of FIG. 5, and each occurrence of this data value pair in the time series data is counted. The third pair of adjacent data points in the table of FIG. 4 is (2,3). This is again a new combination of non-equal values and, therefore, the data value pair is added as a new entry in the table of FIG. 5. The fourth and fifth pairs of adjacent data points in the time series are (3, 1) followed by (1, 0) which are each unique pairs with non-equal values so they are added to the table of FIG. 5. The next pair of adjacent data points in the time series is (0, 0) which is not added to the table because the data values are the same, as described above. The next pair of adjacent data points in the time series is (0, 2). That pair has already been added to the table of FIG. 5 previously so the count for that pair of values is incremented by 1. The time series data is processed until all the unique data value pairs have been identified and the number of occurrences of each data value pair has been counted, as shown in FIG. 5.

In this way, a time-series data set of any number of data points can be condensed and represented by a “count”, or “frequency,” indicating how many times each unique value pairs occurs in the pre-processed time-series data set. Although the original time-series data set cannot be fully reconstructed from the condensed data set (i.e., the “count table”), the condensed data still provides important information regarding the time-series data set. For example, the condensed data set provides an indication/confirmation of how many “events” occurred in which a data value for a telemetry parameter or metric increased or decreased, the number of times that each increase and decrease occurred, as well as the magnitude of the increase or decrease.

The unique data value pairs and their corresponding counts corresponds to the spectral data which is supplied to the visualization unit 240 and used as the basis for generating a visualization graph. A visualization graph includes a plurality of nodes with each node corresponding to a unique data value from the unique data value pairs. FIG. 6 shows an example visualization graph 600 for the spectral data from the table shown in FIG. 5. There are four unique values (i.e., 0, 1, 2, 3) in the spectral data so the graph 600 includes four nodes 602 representing the four values, respectively. The nodes 602 are arranged sequentially around the circumference of an ellipsoid structure 604. Each node representing one of the data values is connected by a respective connector 606 to every other node with which it makes up a unique data value pair in the spectral data. For example, node 0 is connected to node 2 and node 1 to represent the unique value pairs (0, 2) and (1, 0) from the table of FIG. 5. Although not clear from FIG. 6, the manner in which the connectors 606 is depicted can varied to indicate the count, or frequency, associated with each value pair. In embodiments, different colors are used for connectors to indicate different frequencies, or ranges of frequencies, associated with the data value pairs in the time series data. In other embodiments, different line thicknesses, line types, or other characteristics of the connectors may be varied to distinguish frequencies.

In embodiments, the detail of the visualization graph is adjustable by setting and/or selecting minimum and/or maximum thresholds for frequencies required to include data value pairs in the graph. For example, a user may desire to see only see a visualization including data value pairs having a frequency greater than 100 or 1000. In embodiments, the spectral conversion and condensing unit 220 is configured to generate the spectral data with reference to one or more predetermined and/or user selectable frequency threshold values. The generated visualization graph is then be transmitted for display to the client device of the user who submitted the request for visualization.

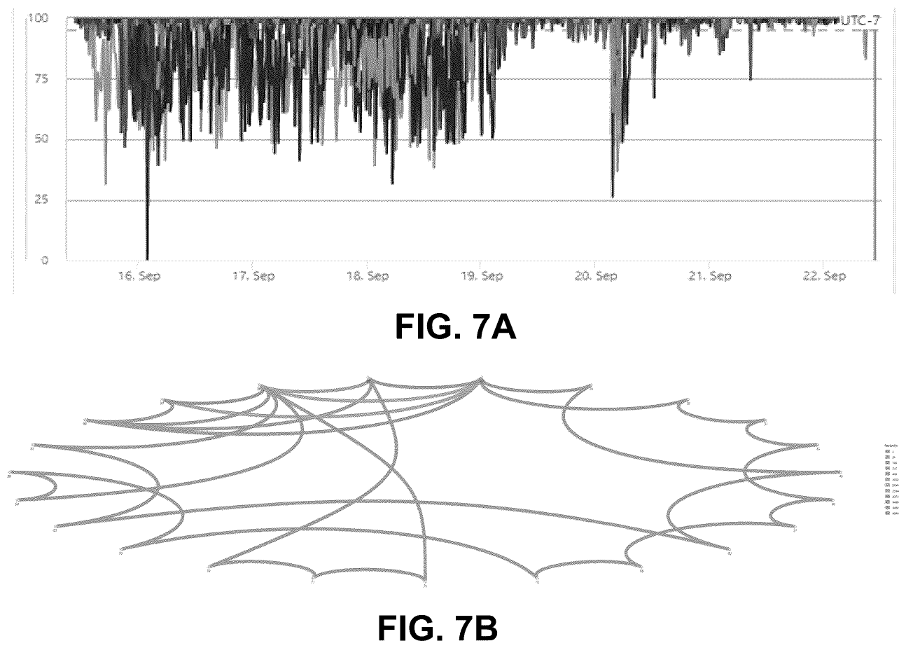

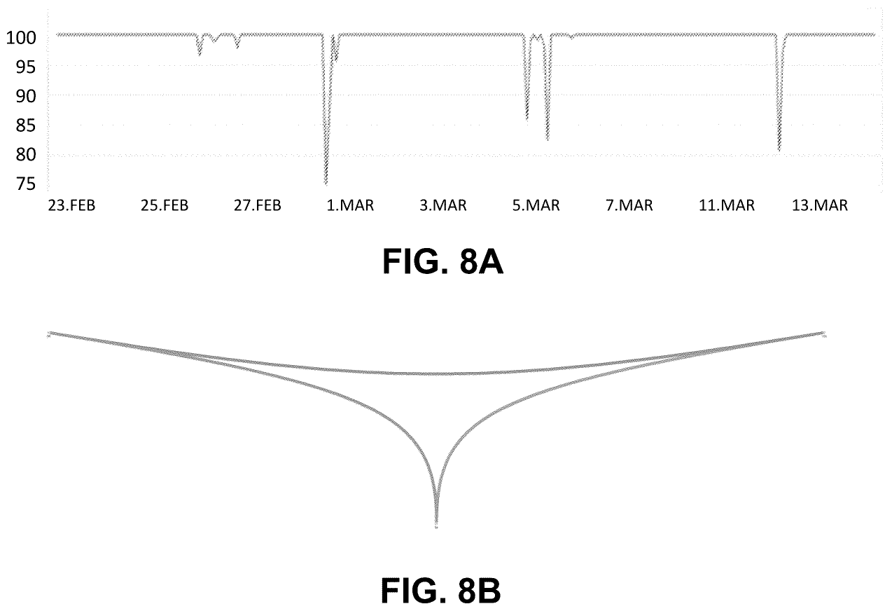

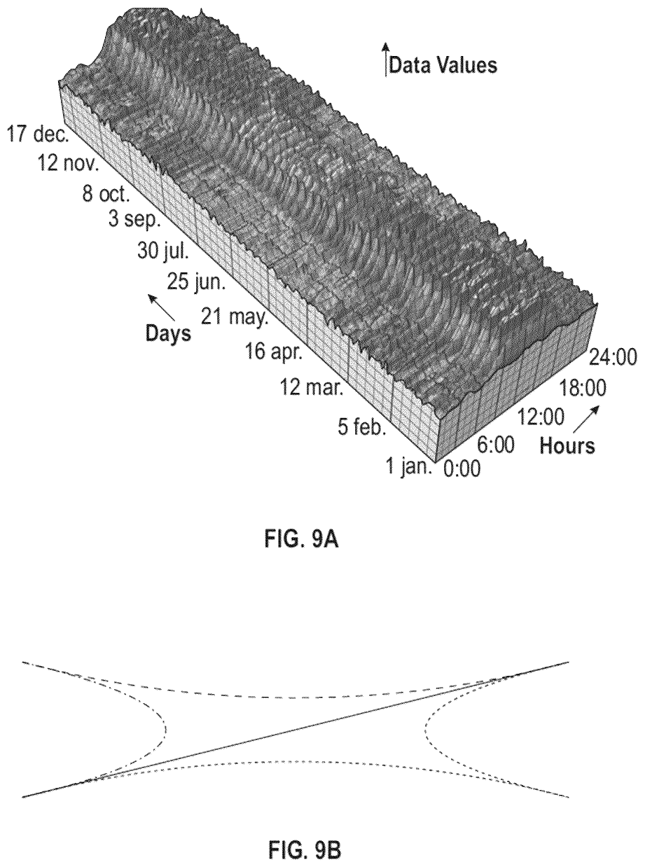

FIGS. 7A and 8A depict two examples of time series telemetry data that could be generated during the execution of the same software application. FIG. 8A represents the time series data generated during a successful, or problem free, operation while FIG. 7A represents the time series data generated during an abnormal (or less successful) occurrence of the same operation. The time series data of FIG. 7A shows a much wider variation in the data values and frequencies of data points. In particular, the time-series of FIG. 7A is “messier” than the time series data of FIG. 8A. However, it would be difficult, if not impossible, for a human operator to garner much meaningful information from the time series as it is depicted in FIG. 7A or 8A. By applying the spectral conversion and condensation process to the time series data and generating visualization graphs for each of these two time-series data sets, the system effectively condenses the data, provides a greatly simplified visual representation of these complex time-series data sets, and provides effective noise suppression. In some implementations, condensing the time-series data as a graphical signature also enables quicker and simplified interpretation and analysis of the original time-series data.

FIGS. 7B and 8B show examples of visualization graphs generated for the time series data of FIGS. 7A and 8A, respectively. The visualization graphs of FIGS. 7B and 8B each include a plurality of nodes which represent each distinct data value from the unique data value pairs in the time series data. The large number of nodes and the large number of connectors indicating low frequency transitions can be quickly and easily identified by an operator as corresponding to a problematic operation, or build. Similarly, the small number of nodes connected by connectors indicating a high number of transitions between the nodes can be quickly and easily identified as a stable operation, or build.

Because the visualization graphs depict large scale analysis of time series data, visualization graphs generated for the same type of telemetry data logs over different time periods should present an overall consistent image. That is because at a high level, telemetry data logs for the same service and/or software application should behave consistently over different time periods. As a result, differences in visualization graphs generated for the same type of telemetry data but over different periods can be indicative of errors, failures or other types of problems with the service and/or software application. Thus, a user reviewing and analyzing the visualization graphs may be able to quickly identify potential problems in the service and/or software application by simply comparing two visualization graphs. However, the visualization graphs described herein also enable much larger data sets generated over longer time periods to be visualized which can show patterns in data that would otherwise not be seen with less data and/or shorter time periods.

In the manner described above, large numbers of time series can be visualized in a simple and easily understandable way that enables quick comparison and identification of fluctuations in the log representations. These fluctuations may help users detect anomalies quickly and efficiently. A user may be able to utilize a user portal to choose the length of time over which the telemetry logs are collected (e.g., logs for one-hour increments, 4-hour increments, 24-hour increments, etc.), the frequency of visualization (e.g., every 6 hours, 3 times a week, etc.), and/or the minimum number of times pairs of words should appear together before their connection is visualized on the graph. Once these parameters are specified, the data processing system may quickly process the data logs to generate the desired visualization graphs.

In addition to manual examination and review of the visualization graphs, one or more machine-learning (ML) models may be trained and utilized to analyze the visualization graphs for detection of specific types of events. For example, a dataset of visualization graphs and corresponding events (e.g., software failures, errors, etc.) or lack of events may be used in a supervised or unsupervised training process to train an ML to analyze visualization graphs of specific types of telemetry data and identify potential areas of concern. The ML model may be trained to automatically generate alerts based on the analysis of the visualization graphs such that a user may be notified of potential errors, failures and the like.

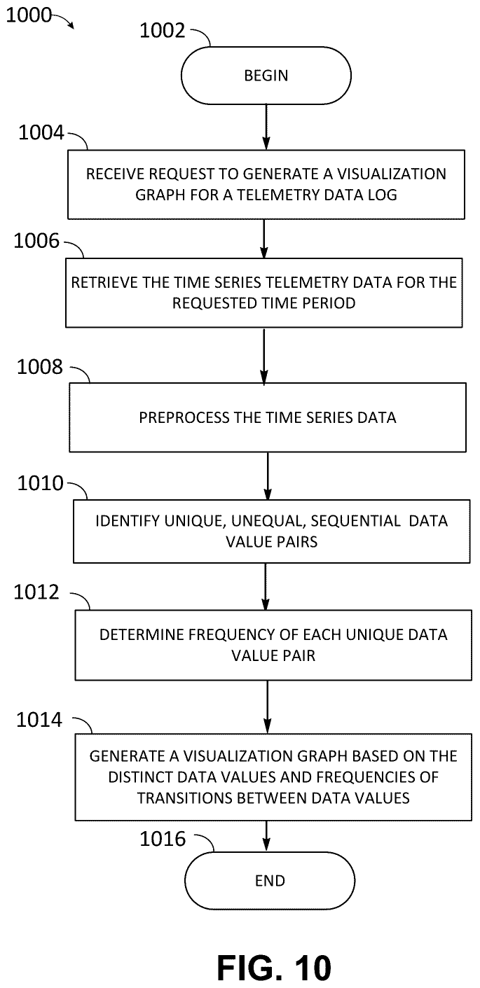

The spectral time series conversion method described herein can also be used to process and visualize 3D time series. FIG. 10A depicts an example of a 3D time series. In embodiments, a 3D time series has first dimension and second dimensions which typically correspond to time increments, such as day and hour, respectively. The third dimension is the operation/process variable and includes the data values of these variables. Different time series may have different operation/process variables. This results in a large number of time series which are arranged side by side as depicted in FIG. 10A. A 3D time series can be processed in a similar manner as the time series discussed above using the spectral conversion method described herein by processing the 3D time series to unique data identify unique sequential data value pairs and counting the number of times each unique data value pair appears in the 3D time series. This enables the 3D time series to be folded and flattened into a compact visualization graph similar to those described above. The 3D time series of FIG. 10A shows an example of a successful performance (e.g., build, update, etc.). FIG. 10B shows an example of the visualization graph that could result from processing the 3D time series of FIG. 10A using the spectral conversion method described herein. The small number of nodes with high frequency connectors indicates consistent variations and stable performance.

FIG. 10 is a flow diagram depicting an example method 1000 for generating a visualization graph for time series telemetry data. One or more steps of the method 1000 may be performed by a data processing engine of a telemetry data server such as the data processing engine 160 of the telemetry data server 170 of FIG. 1. The method 1100 begins (block 1002) and proceeds to receiving a request for generating a visualization graph for a telemetry data log (block 1004). In an example, the request may be received from a user via a user's client device. For example, the request may be submitted via a user portal of a service or application that offers visualization and/or analysis of telemetry data. In an example, the user portal provides options for the user to select one or more parameters for the telemetry data log. For example, the user may be able to select the type of application or service that the telemetry data is associated with. Furthermore, the user may be able to select the duration of time for which the telemetry data should be analyzed and/or a frequency (e.g., generate visualization graphs for 4-hour increments of telemetry data every 2 hours in a given 24-hour period). The user may also be able to set a minimum number of times pairs of terms in the telemetry data should appear in the vicinity of each other before they are visualized on the visualization graph.

After receiving the request, method 1000 proceeds to retrieving the time series telemetry data for the requested time period (block 1006). In embodiments, this is done by retrieving the telemetry data from a telemetry data store. Once the telemetry data is retrieved, the time series telemetry data is pre-processed (block 1008), e.g., by smoothing and/or rounding data values. After pre-processing, unique, unequal, and sequential data value pairs are identified. (block 1010). Once the unique data value airs have been identified, the frequency of each unique data value pair in the time series data is determined. (block 1012). The unique data value pairs and their corresponding frequencies are then used as the basis for generating a visualization graph. (block 1014).

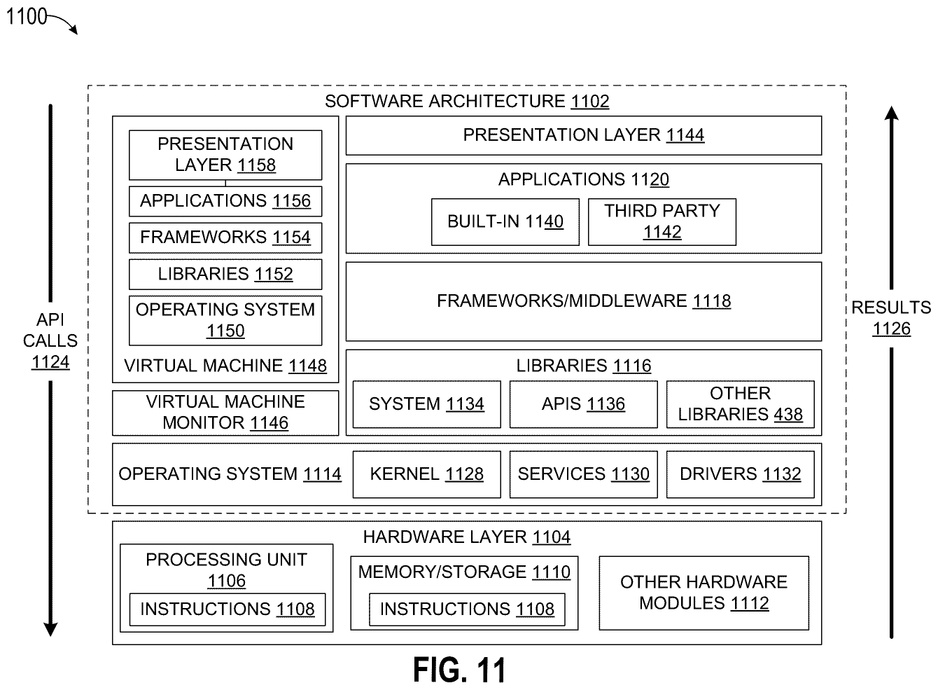

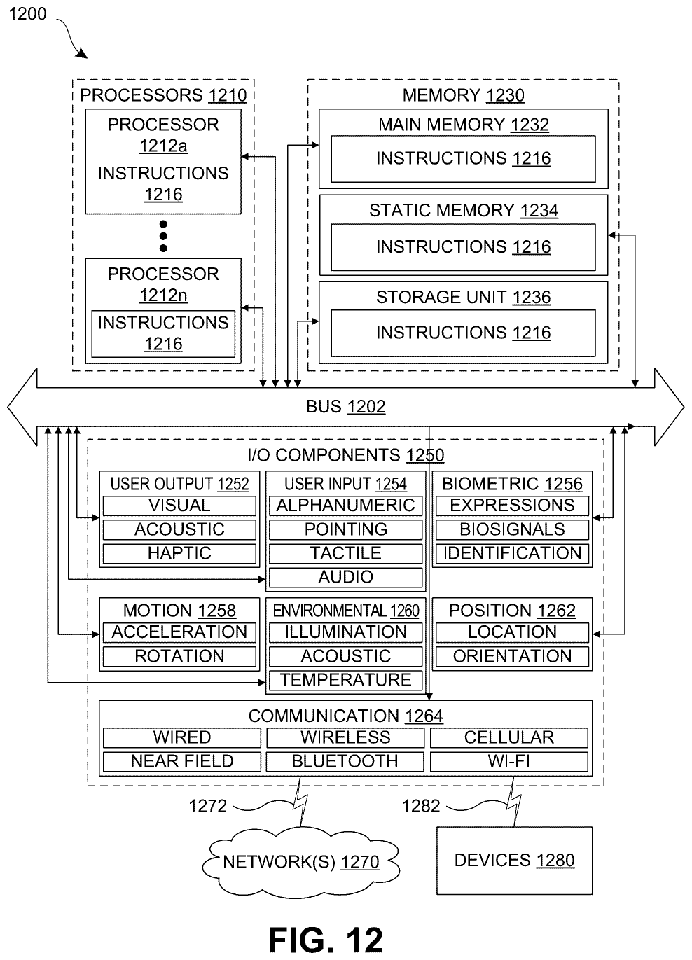

FIG. 11 is a block diagram 1100 illustrating an example software architecture 1102, various portions of which may be used in conjunction with various hardware architectures herein described, which may implement any of the above-described features. FIG. 11 is a non-limiting example of a software architecture and it will be appreciated that many other architectures may be implemented to facilitate the functionality described herein. The software architecture 1102 may execute on hardware such as a machine 1200 of FIG. 12 that includes, among other things, processors 1210, memory 1230, and input/output (I/O) components 1250. A representative hardware layer 1104 is illustrated and can represent, for example, the machine 1200 of FIG. 12. The representative hardware layer 1104 includes a processing unit 1106 and associated executable instructions 1108. The executable instructions 1108 represent executable instructions of the software architecture 1102, including implementation of the methods, modules and so forth described herein. The hardware layer 1104 also includes a memory/storage 1110, which also includes the executable instructions 1108 and accompanying data. The hardware layer 1104 may also include other hardware modules 1112. Instructions 1108 held by processing unit 1108 may be portions of instructions 1108 held by the memory/storage 1110.

The example software architecture 1102 may be conceptualized as layers, each providing various functionality. For example, the software architecture 1102 may include layers and components such as an operating system (OS) 1114, libraries 1116, frameworks 1118, applications 1120, and a presentation layer 1144. Operationally, the applications 1120 and/or other components within the layers may invoke API calls 1124 to other layers and receive corresponding results 1126. The layers illustrated are representative in nature and other software architectures may include additional or different layers. For example, some mobile or special purpose operating systems may not provide the frameworks/middleware 1118.

The OS 1114 may manage hardware resources and provide common services. The OS 1114 may include, for example, a kernel 1128, services 1130, and drivers 1132. The kernel 1128 may act as an abstraction layer between the hardware layer 1104 and other software layers. For example, the kernel 1128 may be responsible for memory management, processor management (for example, scheduling), component management, networking, security settings, and so on. The services 1130 may provide other common services for the other software layers. The drivers 1132 may be responsible for controlling or interfacing with the underlying hardware layer 1104. For instance, the drivers 1132 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1116 may provide a common infrastructure that may be used by the applications 1120 and/or other components and/or layers. The libraries 1116 typically provide functionality for use by other software modules to perform tasks, rather than rather than interacting directly with the OS 1114. The libraries 1116 may include system libraries 1134 (for example, C standard library) that may provide functions such as memory allocation, string manipulation, file operations. In addition, the libraries 1116 may include API libraries 1136 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1116 may also include a wide variety of other libraries 1138 to provide many functions for applications 1120 and other software modules.

The frameworks 1118 (also sometimes referred to as middleware) provide a higher-level common infrastructure that may be used by the applications 1120 and/or other software modules. For example, the frameworks 1118 may provide various graphic user interface (GUI) functions, high-level resource management, or high-level location services. The frameworks 1118 may provide a broad spectrum of other APIs for applications 1120 and/or other software modules.

The applications 1120 include built-in applications 1140 and/or third-party applications 1142. Examples of built-in applications 1140 may include, but are not limited to, a contacts application, a browser application, a location application, a media application, a messaging application, and/or a game application. Third-party applications 1142 may include any applications developed by an entity other than the vendor of the particular platform. The applications 1120 may use functions available via OS 1114, libraries 1116, frameworks 1118, and presentation layer 1144 to create user interfaces to interact with users.

Some software architectures use virtual machines, as illustrated by a virtual machine 1148. The virtual machine 1148 provides an execution environment where applications/modules can execute as if they were executing on a hardware machine (such as the machine 1200 of FIG. 12, for example). The virtual machine 1148 may be hosted by a host OS (for example, OS 1114) or hypervisor, and may have a virtual machine monitor 1146 which manages operation of the virtual machine 1148 and interoperation with the host operating system. A software architecture, which may be different from software architecture 1102 outside of the virtual machine, executes within the virtual machine 1148 such as an OS 1114, libraries 1172, frameworks 1154, applications 1156, and/or a presentation layer 1158.

FIG. 12 is a block diagram illustrating components of an example machine 1200 configured to read instructions from a machine-readable medium (for example, a machine-readable storage medium) and perform any of the features described herein. The example machine 1200 is in a form of a computer system, within which instructions 1216 (for example, in the form of software components) for causing the machine 1200 to perform any of the features described herein may be executed. As such, the instructions 1216 may be used to implement modules or components described herein. The instructions 1216 cause unprogrammed and/or unconfigured machine 1200 to operate as a particular machine configured to carry out the described features. The machine 1200 may be configured to operate as a standalone device or may be coupled (for example, networked) to other machines. In a networked deployment, the machine 1200 may operate in the capacity of a server machine or a client machine in a server-client network environment, or as a node in a peer-to-peer or distributed network environment. Machine 1200 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1200 is illustrated, the term “machine” includes a collection of machines that individually or jointly execute the instructions 1216.

The machine 1200 may include processors 1210, memory 1230, and I/O components 1250, which may be communicatively coupled via, for example, a bus 1202. The bus 1202 may include multiple buses coupling various elements of machine 1200 via various bus technologies and protocols. In an example, the processors 1210 (including, for example, a central processing unit (CPU), a graphics processing unit (GPU), a digital signal processor (DSP), an ASIC, or a suitable combination thereof) may include one or more processors 1212a to 1212n that may execute the instructions 1216 and process data. In some examples, one or more processors 1210 may execute instructions provided or identified by one or more other processors 1210. The term “processor” includes a multi-core processor including cores that may execute instructions contemporaneously. Although FIG. 12 shows multiple processors, the machine 1200 may include a single processor with a single core, a single processor with multiple cores (for example, a multi-core processor), multiple processors each with a single core, multiple processors each with multiple cores, or any combination thereof. In some examples, the machine 1200 may include multiple processors distributed among multiple machines.

The memory/storage 1230 may include a main memory 1232, a static memory 1234, or other memory, and a storage unit 1236, both accessible to the processors 1210 such as via the bus 1202. The storage unit 1236 and memory 1232, 1234 store instructions 1216 embodying any one or more of the functions described herein. The memory/storage 1230 may also store temporary, intermediate, and/or long-term data for processors 1210. The instructions 1216 may also reside, completely or partially, within the memory 1232, 1234, within the storage unit 1236, within at least one of the processors 1210 (for example, within a command buffer or cache memory), within memory at least one of I/O components 1250, or any suitable combination thereof, during execution thereof. Accordingly, the memory 1232, 1234, the storage unit 1236, memory in processors 1210, and memory in I/O components 1250 are examples of machine-readable media.

As used herein, “machine-readable medium” refers to a device able to temporarily or permanently store instructions and data that cause machine 1200 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1216) for execution by a machine 1200 such that the instructions, when executed by one or more processors 1210 of the machine 1200, cause the machine 1200 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1250 may include a wide variety of hardware components adapted to receive input, provide output, produce output, transmit information, exchange information, capture measurements, and so on. The specific I/O components 1250 included in a particular machine will depend on the type and/or function of the machine. For example, mobile devices such as mobile phones may include a touch input device, whereas a headless server or IoT device may not include such a touch input device. The particular examples of I/O components illustrated in FIG. 12 are in no way limiting, and other types of components may be included in machine 1200. The grouping of I/O components 1250 are merely for simplifying this discussion, and the grouping is in no way limiting. In various examples, the I/O components 1250 may include user output components 1252 and user input components 1254. User output components 1252 may include, for example, display components for displaying information (for example, a liquid crystal display (LCD) or a projector), acoustic components (for example, speakers), haptic components (for example, a vibratory motor or force-feedback device), and/or other signal generators. User input components 1254 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1250 may include biometric components 1256, motion components 1258, environmental components 1260, and/or position components 1262, among a wide array of other physical sensor components. The biometric components 1256 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1258 may include, for example, acceleration sensors (for example, an accelerometer) and rotation sensors (for example, a gyroscope). The environmental components 1260 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1262 may include, for example, location sensors (for example, a Global Position System (GPS) receiver), altitude sensors (for example, an air pressure sensor from which altitude may be derived), and/or orientation sensors (for example, magnetometers).

The I/O components 1250 may include communication components 1264, implementing a wide variety of technologies operable to couple the machine 1200 to network(s) 1270 and/or device(s) 1280 via respective communicative couplings 1272 and 1282. The communication components 1264 may include one or more network interface components or other suitable devices to interface with the network(s) 1270. The communication components 1264 may include, for example, components adapted to provide wired communication, wireless communication, cellular communication, Near Field Communication (NFC), Bluetooth communication, Wi-Fi, and/or communication via other modalities. The device(s) 1280 may include other machines or various peripheral devices (for example, coupled via USB).

In some examples, the communication components 1264 may detect identifiers or include components adapted to detect identifiers. For example, the communication components 1264 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1262, such as, but not limited to, geo-location via Internet Protocol (IP) address, location via Wi-Fi, cellular, NFC, Bluetooth, or other wireless station identification and/or signal triangulation.

In the following, further features, characteristics and advantages of the invention will be described by means of items:
Item 1. A data processing system comprising:
   a processor; and
   a memory in communication with the processor, the memory comprising executable instructions that, when executed by the processor, cause the data processing system to perform functions of:
      identifying each unique data value pair in at least one time series telemetry data generated based on operation of at least one software application, each of the unique data value pairs including a first data value and a second data value, the first data value being generated at a first time in the time series, the second data value being generated at a second time in the time series, the second time being immediately before or after the first time, and wherein the first data value is different than the second data value;
      determining a frequency of occurrence of each of the unique data value pairs in the time series telemetry data; and
      generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.
Item 2. The data processing system of item 1, wherein the visualization graph is a spectral ellipsoid.
Item 3. The data processing system of any of items 1-2, wherein the plurality of nodes is arranged along a circumference of the spectral ellipsoid.
Item 4. The data processing system of any of items 1-3, wherein each of the connectors is depicted in a manner that depends on the frequency of the occurrence of the unique data value pair represented by the nodes between which each of the connectors extends.
Item 5. The data processing system of any of items 1-4, wherein the connectors associated with different frequencies are depicted with different colors.
Item 6. The data processing system of any of items 1-5, wherein the functions further include:
   preprocessing the time series telemetry data before identifying each of the unique data value pairs.
Item 7. The data processing system of any of items 1-6, wherein the preprocessing includes performing a smoothing process on the time series telemetry data.
Item 8. The data processing system of any of items 1-7, wherein the preprocessing includes performing a rounding process on the time series telemetry data.
Item 9. The data processing system of any of items 1-8, wherein a trained machine-learning model is configured to analyze the visualization graph to detect one or more events associated with the software application.
Item 10. A method for generating a visualization graph for telemetry data comprising:
   preprocessing at least one time series telemetry data generated based on operation of at least one software application by smoothing and/or rounding data values in the time series data;
   identifying each unique data value pair in the time series telemetry data, each of the unique data value pairs including a first data value and a second data value, the first data value being generated at a first time in the time series, the second data value being generated at a second time in the time series, the second time being immediately before or after the first time, and wherein the first data value is different than the second data value;
   determining a frequency of occurrence of each of the unique data value pairs in the time series telemetry data; and
   generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.
Item 11. The method of item 10, wherein the visualization graph has an ellipsoid shape.
Item 12. The method of any of items 10-11, wherein the plurality of nodes are arranged along a circumference of the ellipsoid shape.
Item 13. The method of claim any of items 10-12, wherein each of the connectors is depicted in a manner that represents the frequency of the occurrence of a unique data value pair represented by the nodes connected by the connector.
Item 14. The method of any of items 10-13, wherein the connectors associated with different frequencies are depicted with different colors.
Item 15. The method of any of items 10-14, wherein the functions further include:
   analyzing the visualization graph using a trained machine-learning model to detect one or more events associated with the software application.
Item 16. A non-transitory computer readable medium on which are stored instructions that, when executed, cause a programmable device to perform functions of:
   identifying each unique data value pair in the time series telemetry data, each of the unique data value pairs including a first data value and a second data value, the first data value being generated at a first time in the time series, the second data value being generated at a second time in the time series, the second time being immediately before or after the first time, and wherein the first data value is different than the second data value;
   determining a count of occurrences of each of the unique data value pairs in the time series telemetry data; and
   generating a visualization graph for the time series telemetry data that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.
Item 17. The non-transitory computer readable medium of any of items 10-16, wherein the functions further include:
   preprocessing the time series telemetry data before identifying each of the unique data value pairs by smoothing and/or rounding data values in the time series telemetry data.
Item 18. The non-transitory computer readable medium of any of items 10-17, wherein the visualization graph has an ellipsoid shape and the plurality of nodes are arranged along a circumference of the ellipsoid shape.
Item 19. The non-transitory computer readable medium of any of items 10-18, wherein each of the connectors is depicted in a manner that depends on the frequency of the occurrence of the unique data value pair represented by the nodes between which each of the connectors extends.
Item 20. The non-transitory computer readable medium of any of items 10-19, wherein the connectors associated with different frequencies are depicted with different colors.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
identifying a plurality of unique data value pairs in at least one time series of telemetry data generated based on operation of at least one software application, each of the unique data value pairs including a first data value and a second data value, the first data value being generated at a first time in the time series, the second data value being generated at a second time in the time series, the second time being immediately before or after the first time, and wherein the first data value is different than the second data value;
determining a frequency of occurrence of each of the unique data value pairs in the time series; and
generating a visualization graph for the time series that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

2. The data processing system of claim 1, wherein the visualization graph is a spectral ellipsoid.

3. The data processing system of claim 2, wherein the plurality of nodes is arranged along a circumference of the spectral ellipsoid.

4. The data processing system of claim 1, wherein each of the connectors is depicted in a manner that depends on the frequency of the occurrence of the unique data value pair represented by the nodes between which each of the connectors extends.

5. The data processing system of claim 4, wherein the connectors associated with different frequencies are depicted with different colors.

6. The data processing system of claim 1, wherein the functions further include:
pre-processing the time series before identifying each of the unique data value pairs.

7. The data processing system of claim 6, wherein the pre-processing includes performing a smoothing process on the time series.

8. The data processing system of claim 6, wherein the pre-processing includes performing a rounding process on the time series.

9. The data processing system of claim 1, wherein a trained machine-learning model is configured to analyze the visualization graph to detect one or more events associated with the software application.

10. A method for generating a visualization graph for telemetry data comprising:
pre-processing at least one time series of telemetry data generated based on operation of at least one software application by smoothing and/or rounding data values in the time series;
identifying each unique data value pair in the time series, each of the unique data value pairs including a first data value and a second data value, the first data value being generated at a first time in the time series, the second data value being generated at a second time in the time series, the second time being immediately before or after the first time, and wherein the first data value is different than the second data value;
determining a frequency of occurrence of each of the unique data value pairs in the time series; and
generating a visualization graph for the time series that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

11. The method of claim 10, wherein the visualization graph has an ellipsoid shape.

12. The method of claim 11, wherein the plurality of nodes is arranged along a circumference of the ellipsoid shape.

13. The method of claim 10, wherein each of the connectors is depicted in a manner that represents the frequency of the occurrence of the unique data value pair represented by the nodes connected by the connector.

14. The method of claim 13, wherein the connectors associated with different frequencies are depicted with different colors.

15. The method of claim 10, further comprising:
analyzing the visualization graph using a trained machine-learning model to detect one or more events associated with the software application.

16. A non-transitory computer readable medium on which are stored instructions that, when executed, cause a programmable device to perform functions of:
identifying each unique data value pair in at least one time series of telemetry data, each of the unique data value pairs including a first data value and a second data value, the first data value being generated at a first time in the time series, the second data value being generated at a second time in the time series, the second time being immediately before or after the first time, and wherein the first data value is different than the second data value;
determining a count of occurrences of each of the unique data value pairs in the time series; and
generating a visualization graph for the time series that includes a plurality of nodes and a plurality of connectors extending between the nodes, each of the nodes representing a distinct data value from the unique data value pairs, respectively, and each of the connectors extending between two of the nodes which together represent the data values from one of the unique data value pairs.

17. The non-transitory computer readable medium of claim 16, wherein the functions further include:
pre-processing the time series before identifying each of the unique data value pairs by smoothing and/or rounding data values in the time series.

18. The non-transitory computer readable medium of claim 16, wherein the visualization graph has an ellipsoid shape and the plurality of nodes are arranged along a circumference of the ellipsoid shape.

19. The non-transitory computer readable medium of claim 16, wherein each of the connectors is depicted in a manner that depends on the count of the occurrence of the unique data value pair represented by the nodes between which each of the connectors extends.

20. The non-transitory computer readable medium of claim 19, wherein the connectors associated with different frequencies are depicted with different colors.
